(19) United States
(12) Patent Application Publication
(10) Pub. No.: US 2008/0311252 A1
(43) Pub. Date: Dec. 18, 2008

(54) Chocolate based dietary supplement product or sweet beverage product

(76) Inventors: Jonathan A. Selzer, Cheshire, CT (US); Lloyd Lirio, New Haven, CT (US); Leah Haibi, Meriden, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/818,201

(22) Filed: Jun. 13, 2007

(51) Int. Cl. A23L 1/30; A23L 1/302

(52) U.S. Cl. 426/72; 426/542

(57) ABSTRACT

A cocoa based dietary supplement or functional food beverage product is revealed with enhanced flavor and health characteristics. Cocoa sources are combined with extracts of the fruit of Lo Han and/or extracts from the leaves of Stevia rebaudiana and/or extracts from the leaves of Chinese Blackberry. Green tea extract or white tea extract can be added to improve the antioxidant profile of the product. The resulting product is a pleasant tasting dietary supplement, which is easily absorbed by the body in liquid form, and provides substantial therapeutic effects.

### FIELD OF THE INVENTION

The present invention relates to chocolate based compositions with improved antioxidant content and taste, and to a method for using such compositions as dietary supplements, and/or therapeutic supplements, and/or sweet functional food beverage product. Chocolate is made from cocoa powder. Functional foods are defined as any conventional food that has been fortified to improve its nutritional value or is claimed to have health-promoting benefits above and beyond its normal nutritional value.

### BACKGROUND OF THE INVENTION

The uses of chocolate as a therapeutic supplement are manifold and well documented in the scientific literature. Current research around the world is substantiating further claims for traditional herbal medicines.

The most well documented therapeutic effect of chocolate concerns its antioxidant properties. Free radical damage, which can be reduced by antioxidants, has been implicated in a great many diseases and conditions, from Parkinson's disease to coronary heart disease and cancer. Furthermore, recent studies have shown that cocoa is a very potent antioxidant and can also help to protect LDL cholesterol from free-radical damage. Cocoa extract has been shown to block the damaging effects of UV radiation on human epithelial cells.

Recent studies have also demonstrated the effects of cocoa on heart health. The consumption of cocoa extract has been shown to improve blood vessel elasticity and reverse damage to vessels caused by smoking. One new study showed how chocolate improves platelet function and reduced the progression of blood clots. Finally, cocoa has demonstrated the ability to decrease blood pressure.

Cocoa flavanols have been shown to improve brain function and mental clarity. This is a result of improved blood flow to the brain and the presence of methylxanthines, which improve mental clarity and the ability to concentrate. Clinical trials have shown that cocoa flavanols improve MRI response in subjects.

Recent studies have demonstrated that cocoa flavanols are beneficial for those suffering from diabetes. One study showed its ability to ameliorate insulin sensitivity in diabetics.

Finally, cocoa flavanols have demonstrated various anti-cancer properties and the related protection from UV radiation has already been mentioned above. Further studies have shown that it has an anti-tumor effect in mice.

Even before the appearance of scientific literature, many people have been consuming chocolate products as a normal food product. It is usually combined with milk products and sugar to make it more palatable and less bitter.

Chocolate, both extracts and powders, utilized in products are of varying qualities, ranging from pure cocoa powder with high cocoa solids to an extract of cocoa with high polyphenol (flavanol) content. By far, the latter contains more highly concentrated forms of the components in chocolate, which are considered responsible for its therapeutic effects. Pure chocolate powder and its extract are bitter in taste. Most products, which use chocolate powder, contain sweeteners, such as sugars, high fructose corn syrup and artificial alternatives, such as sucralose or saccharin.

Thus, it is an object of this invention to reveal a chocolate based composition with sufficient cocoa and cocoa polyphenol concentration such that it provides substantial beneficial and therapeutic effects when consumed yet has a pleasant flavor. It is a further object to this invention to enhance the therapeutic benefits of chocolate by combining it with flavor enhancing additives which themselves have beneficial therapeutic properties but which do not have the problems associated with the use of sugar.

### SUMMARY OF THE INVENTION

The inventors herein propose combining cocoa powder and cocoa powder extract with one or more additives selected from the group consisting of extracts derived from the fruits of Lo Han (i.e. Luo Han), extracts derived from the leaves of stevia, and/or, extracts derived from the leaves of Chinese Blackberry to produce an aqueous drink. The inventors have discovered that dietary supplements prepared in accordance with the foregoing, produce a great tasting herbal product which possesses many beneficial therapeutic properties, including the ability to boost the body's antioxidant levels, increase antibiotic properties and the ability to improve the skin.

### DETAILED DESCRIPTION OF THE INVENTION

The inventors herein propose a dietary supplement and/or beverage product comprising:
(a) cocoa powder, cocoa extract with a polyphenol content of preferably between 10% and 90% by weight; and
(b) at least one additive selected from the group consisting of (i) extracts of the fruits of Lo Han, (ii) extracts from the leaves of Stevia, and (iii) extracts from the leaves of Chinese Blackberry.
   Additional optional ingredients include xylitol, fructose or other preferably low glycemic sugars, green tea extract, white tea extract, coffee bean extract, vitamins, minerals, other herbal extracts, stabilizers such as Chinese licorice root extracts, and thickeners or gelling agents. The combination of the foregoing ingredients provides a great tasting dietary supplement or sweet functional food beverage product which possesses the therapeutic properties provided for herein.

The dietary supplement or functional food beverage product described herein requires a source of chocolate. The inventors have found cocoa powder and/or cocoa extract to be useful sources of chocolate for use in this invention. Cocoa extract is preferred because of its concentrated form and can be manufactured to have a polyphenol content of between 5% and 90% by weight. In choosing a source of cocoa extract, it is preferred that the source of cocoa not be subjected to high temperatures in its manufacture, since excessive heating is believed to degrade certain beneficial constituents of cocoa. Cocoa powder is also preferred because it presents the most natural concentrated form of cocoa with the lowest potential of losing beneficial cocoa constituents through its processing. The cocoa powder can be alkylized or not, depending on the finished product desired. Alkylized cocoa powder, also called “dutched chocolate” is manufactured by treating cocoa powder with potassium carbonate. This process improves flavor and solubility in aqueous solutions, such as tea or tea concentrates. The concentration of cocoa powder and extract in the dietary supplement, on a dry basis, may range from about 1% to 25% by weight. In the functional food beverage product, the concentration of cocoa powder and extract, on a dry basis, is preferably from about 1% to 10% by weight. Preferably the concentration of polyphenols in the product is from 0.1% to 22.5% by weight, most preferably from 0.5% to 5% by weight.

The dietary supplement or functional food beverage product described herein also requires at least one additive selected from the group consisting of (i) extracts of the fruits of Lo Han, (ii) extracts from the leaves of Stevia, and (iii) extracts from the leaves of Chinese Blackberry. Preferably more than one or all of the foregoing additives are present in the composition. The concentration of the foregoing additives in the composition may range depending upon the concentration of the extracts themselves. Generally, these extracts are provided as dried powders and if so, the concentration of these additives in the composition of this invention will range from about 0.05% to 6% by weight but is preferably from about 0.05% to 1% by weight.

Lo Han fruit comes from Momordica grosvenorii, also called Siraitia grosvenorii. Lo Han is native to the People's Republic of China and Japan and is an edible fruit having an intensely sweet taste. It is reputed to possess healing properties for lung congestion, colds, sore throats, digestive and urinary disturbances, as well as antibiotic and antiseptic properties. Extracts of both fresh and dried Lo Han are available throughout the world, and can be readily purchased. One suitable aqueous extract is available from the Benyo Phytochemical Company, located in China. Various methods are known for preparing extracts of the Lo Han fruit, and other natural sources, such as those methods described in the U.S. Pat. Nos. 6,124,442 and 4,084,010, the teachings each of which are incorporated herein by reference in their entirety.

The preferred extracts of Lo Han are prepared as noted above using water or water/alcohol mixtures to extract the active species from the plant, thereby creating an aqueous extract. One such preferred method is described in U.S. Pat. No. 6,124,442, wherein the starting plant source material is fresh plant material such as cut pieces of freshly harvested Lo Han fruit. These fresh plant pieces are extracted by soaking in a bath of heated (80° F.-212° F.) water, alcohol (preferably ethanol) or both. This initial process is preferably carried out in hot, preferably boiling water or water/alcohol mixture. Extraction in the bath may be carried out several times, each time saving the resulting liquid. The resulting extract liquid is then filtered through a suitable filter, such as a 40-mesh stainless steel screen. The thus-obtained solid material can then be extracted again. It may be preferable for a particular process to carry out more or less extraction steps with different volumes of liquid being used for each boiling or extraction step. The result of this extraction process is an aqueous, alcohol or aqueous/alcohol extract that can be used in the composition of this invention. The extract can be used directly or concentrated by evaporation or spray drying and then used. Other extracts herein such as extract of the leaves of Stevia, or extracts of the leaves of Chinese Blackberry, or the extract of cocoa beans or cocoa powder are made in the same way. If alcohol is used, alone or with water, it is preferably ethanol.

Stevia rebaudiana (Stevia) is also a plant which is native to the People's Republic of China. Extracts from the leaves of Stevia are commonly known and have been used as a natural sweetener in Asia for many years. Studies have demonstrated that extracts from the leaves of Stevia can have a variety of beneficial therapeutic effects including antibiotic properties especially against E. coli, vasodilatation properties, especially in the kidneys, anti-hypertensive effects, beneficial effects on pancreatic beta cells, and enhancing the secretion of insulin. Extracts from the leaves of Stevia are known and can be purchased for use in formulating the compositions described herein. These extracts can be prepared using the same or similar techniques used for preparing extracts for Lo Han as noted above. One suitable aqueous extract is available from the Benyo Phytochemical Company located in China.

Extracts from the leaves of Chinese Blackberry (Rubus suavissimus) are also known and can be purchased for use in formulating the compositions described herein. One suitable aqueous extract is available from the Benyo Phytochemical Company located in China. The active ingredients in these extracts are believed to comprise diterpene glycosides. Extracts of the leaves of Chinese Blackberry have been used as natural sweeteners. A variety of therapeutic benefits have been ascribed to extracts of the leaves of Chinese Blackberry, including relief from pre-menstrual syndrome, beneficial effects upon the kidney, and other beneficial effects. Extracts of the leaves of Chinese Blackberry can be prepared using the same or similar techniques used for preparing extracts of Lo Han, as noted above.

As noted, other optional materials may be included in the composition of this invention. Green tea extract, white tea extract, coffee bean extract are powerful antioxidants, containing high levels of polyphenols. These herbal extracts are very effective at improving the antioxidant level of the chocolate product and are suggested additives. Vitamins, minerals or other herbal extracts may be added for particular purposes or effects. Sugars such as fructose may be added but are not recommended. Artificial sweeteners or polyols, such as xylitol may be added and may be beneficial in formulating the compositions of this invention. Preferably the composition is substantially free of sucrose. Other flavoring agents such as natural chocolate flavor may also be utilized. Glycerin has also proven to be a beneficial additive.

The Green tea and white tea extracts in this invention are known and are available in various grades from Lycome Industries, Shanxii, China. Coffee bean extract is available from Blue California, a supplier of extracts to the dietary supplement industry.

In preparing the compositions of this invention for use as dietary supplements, the ingredients noted herein are merely combined with water in the concentrations noted to form a dietary supplement drink. It is recommended that the consumer of the product ingest three or more four-ounce servings of the diluted product per day, such that approximately 300 mg of cocoa on a dry basis are ingested per day. Preferably each serving of the product contains from 20 mg to 150 mg of polyphenol content. This concentration of polyphenols in each 3 to 4 ounce serving is achieved by using high polyphenol content extract of cocoa beans. In preparing the compositions described herein as a functional food beverage, the ingredients taught herein are combined with larger quantities of water and appropriate stabilizers.

The compositions of this invention are further described in the following examples which should be taken as illustrative only and not limiting in any manner.

### EXAMPLE I

A cocoa based dietary supplement was prepared using the following ingredients:

| Component | % by Weight |
|---|---|
| Cocoa extract¹ | 1.0 |
| Cocoa powder² | 4.0 |
| White tea extract³ | 3.0 |
| Lo Han extract powder⁴ | 2.5 |
| Natural chocolate flavor⁵ | 2.5 |
| Glycerin | 33.0 |
| Water | 45.0 |

¹Available from the Naturex/Brucia Company
²Available from Ciranda Company
³Available from Lycome Industries, Shanxii, China
⁴Available from Benyo Phytochemical Company
⁵Available from the Virginia Dare Company

The foregoing ingredients were blended to form a pleasant tasting dietary supplement which is believed to exhibit the beneficial therapeutic effects noted herein.

### EXAMPLE II

Example I was repeated except that Stevia extract powder (available from Benyo Phytochemical Company) was substituted for the Lo Han extract powder at the same concentration. The same results were achieved.

### EXAMPLE III

Example I was repeated except that Chinese Blackberry extract powder (available from Shaanxi Company) was substituted for the Lo Han extract powder at the same concentrations. The same results were achieved.

### EXAMPLE IV

A cocoa based dietary supplement was prepared using the following ingredients:

| Component | % by Weight |
|---|---|
| Cocoa extract | 1.0 |
| Lo Han extract powder | 1.5 |
| Cocoa powder | 2.5 |
| Natural cocoa flavor | 2.5 |
| Glycerin | 33.0 |
| Water | 50.5 |

The foregoing ingredients were blended to form a pleasant tasting dietary supplement which is believed to exhibit the beneficial therapeutic effects noted herein.

### EXAMPLE V

A chocolate based functional food beverage was prepared using the following ingredients:

| Component | % by Weight |
|---|---|
| Cocoa extract | 5.0 |
| Cocoa powder | 1.0 |
| Green tea extract | 2.0 |
| Lo Han extract powder | 1.5 |
| water | 90.5 |

The foregoing ingredients were blended and pasteurized to form a functional food beverage.

What is claimed is:

1. A composition useful as a dietary supplement or a functional food beverage product, which composition comprises:
(a) a source of chocolate selected from the group consisting of cocoa powder and cocoa extract and combinations of the foregoing; and
(b) at least one sweetener selected from the group consisting of (i) extracts of the fruits of Lo Han, (ii) extracts of the leaves of Stevia, and (iii) extracts of the leaves of Chinese Blackberry; and optionally

2. A composition according to claim 1, wherein the composition also comprises at least one material selected from the group consisting of green tea extract, white tea extract, vitamins, fructose, glycerin, thickeners, gelling agents, xylitol.

3. A composition according to claim 1, wherein the composition is substantially free of sucrose.

4. A composition according to claim 1, wherein the concentration of the source of cocoa extract and cocoa powder, on a dry basis, is from about 5% to 15% by weight.

5. A composition according to claim 1, wherein the concentration of the additive(s), on a dry basis, is from about 0.05% to 5.0% by weight.

6. A composition according to claim 2, wherein the composition is substantially free of sucrose.

7. A composition according to claim 2, wherein the concentration of the source of cocoa, on a dry basis, is from about 5% to 15% by weight.

8. A composition according to claim 2, wherein the concentration of the additive(s), on a dry basis, is from about 0.05% to 5.0% by weight.

9. A composition according to claim 1, wherein the composition comprises cocoa extract which cocoa extract has a polyphenol concentration from 5% to 90% by weight.

10. A composition according to claim 9, wherein the composition comprises from 1% to 25% by weight of the cocoa extract.

11. A composition according to claim 1, wherein the polyphenol content of the composition is from 0.1% to 22.5% by weight.

12. A composition according to claim 11, wherein the polyphenol content of the composition is from 0.5% to 5% by weight.

13. A composition according to claim 11, wherein the composition also comprises at least one material selected from the group consisting of green tea extract, white tea extract, vitamins, fructose, glycerin, thickeners, gelling agents and xylitol.

14. A composition according to claim 11, wherein the composition also comprises either green tea extract or white tea extract.

15. A composition according to claim 1, wherein each 3 to 4 ounce serving comprises from 20 mg of polyphenols to 150 mg of polyphenols.

16. A composition according to claim 15, wherein the composition is substantially free of sucrose.

17. A composition according to claim 15, wherein the composition comprises cocoa extract and cocoa powder.

18. A composition according to claim 17, wherein the composition also comprises either green tea extract or white tea extract.
